(19) United States
(12) Patent Application Publication
(10) Pub. No.: US 2024/0255965 A1
(43) Pub. Date: Aug. 1, 2024

(54) METHOD AND SYSTEM FOR CHARACTERIZING, IN REAL TIME, ATMOSPHERIC CONDITIONS IN AN ENVIRONMENT OF AN AIRCRAFT, DRONES IMPLEMENTED IN THIS SYSTEM, AND AIRCRAFT IMPLEMENTING SUCH A SYSTEM

(71) Applicant: Flying Whales, Suresnes (FR)

(72) Inventors: Damien Scelo, Suresnes (FR); Pauline Rotach, Suresnes (FR); Kewin Settier, Suresnes (FR); Frédéric Hauviller, Suresnes (FR)

(21) Appl. No.: 18/290,638

(22) PCT Filed: Jul. 21, 2022
(86) PCT No.: PCT/FR2022/051456

§ 371 Date: Feb. 7, 2024

(30) Foreign Application Priority Data
Jul. 21, 2021 (FR) FR2107885

(51) Int. Cl. G05D 1/692; G01W 1/08; G05D 105/80; G05D 109/25

(52) U.S. Cl. CPC G05D 1/692; G01W 1/08; G05D 2105/80; G05D 2109/254

(57) ABSTRACT

A method for characterizing, in real time, atmospheric conditions in the environment of an aircraft, comprises steps of deploying, at a distance from the aircraft, a plurality of drones carrying equipment for characterizing atmospheric conditions, of calculating and transmitting positioning instructions for each drone with respect to the aircraft, of collecting, at one or more of these drones, measured data or calculated data regarding atmospheric variables, of transmitting these measured data thus collected from these drones to the aircraft, and processing these measured data thus transmitted so as to identify one or more atmospheric phenomena liable to affect the static and/or dynamic behavior of the aircraft.

### CROSS REFERENCE TO RELATED APPLICATIONS

This application is a national phase entry under 35 U.S.C. § 371 of International Patent Application PCT/FR2022/051456, filed Jul. 21, 2022, designating the United States of America and published as International Patent Publication WO 2023/002135 A1 on Jan. 26, 2023, which claims the benefit under Article 8 of the Patent Cooperation Treaty to French Patent Application Serial No. FR2107885, filed Jul. 21, 2021.

### TECHNICAL FIELD

The present disclosure relates to a method for characterizing, in real time, atmospheric conditions that are liable to affect the flight conditions of an aircraft, in particular, an airship. It also relates to a system for characterizing atmospheric conditions in real time and to drones implemented in such a characterization system.

### BACKGROUND

Large airships carrying heavy loads are particularly sensitive to gusts of wind when they are stationary in order to perform loading or unloading operations over a site. To counter these gusts of wind, it is important to anticipate them so that the lateral propellers can be engaged in a timely manner.

Wind speed is measured using an anemometer. Meteorologists measure the “instantaneous” wind over a period of three seconds and the “mean” wind over a period of 10 minutes at 10 m above ground height.

A gust is characterized by a sudden instantaneous change in the wind, in terms of either speed or direction, increasing the instantaneous wind with respect to its mean speed to more than 5 m/s.

Gusts can be detected by means of LIDAR equipment installed on the airship. Mention may be made, in particular, to document WO 2016/188759 A1, which discloses an airship equipped multiple LIDAR (pulsed laser, wavelength of 1.54 μm) sensors that allow the wind speed to be measured in both the horizontal and the vertical directions at a distance of between 40 m and 400 m from the airship.

Depending on the wind in the work zone worked out using all of this information, the system has to inform the pilot as to its performance (maintaining altitude, controllability, etc.) by using the apparent mass of the airship, the power reserve (fans/propellers), and the wind calculated in a given reference frame (x, y, z), for example, the reference frame of the aircraft or the terrestrial reference frame. This information can lead to a NO-GO (if the power margin is too small), but the pilot will not be able to calculate it themself.

In the event that work in the zone goes ahead (the decision before arriving was “GO,”) the information (either a change in the wind, or gusts) has to be transmitted to the electric propellers and fans in order to anticipate and minimize the effects of the gusts that have been detected.

Each LIDAR sensor comprises at least two measurement lines for measuring two wind speed coordinates, and four measurement lines for measuring a third wind speed coordinate. This airship comprises six LIDAR sensors, i.e., at least 24 measurement lines.

However, it appears to be necessary to supplement these LIDAR measurements with other measurements performed at a greater distance and in more complex spatial configurations than just the horizontal and vertical components.

Before determining the gusts in the work zone (second step in the operation), the x, y and z components of the wind in the terrestrial reference frame in the work zone have to be known in advance in order to avoid operating in a zone where the air conditions will not allow stabilization and stationary holding with a sufficient power margin and room for maneuver to hold stationary in a precise manner within the standards set by the operations.

The aim of the present disclosure is thus to provide a novel approach for characterizing atmospheric conditions in the environment of an aircraft, in particular, of an airship, which makes it possible, in particular, to anticipate propulsive actions in order to correct for the risk of the aircraft moving as a result of being subjected to a sudden change in these atmospheric conditions.

### BRIEF SUMMARY

One aim of the present disclosure is notably to remedy all or part the aforementioned drawbacks.

According to a first aspect of the present disclosure, a method is provided for characterizing, in real time, atmospheric conditions in the environment of an aircraft, the method comprising the following steps:
(E1) deploying, at a distance from the aircraft, a plurality of drones carrying equipment for characterizing atmospheric conditions,
(E2) calculating and transmitting instructions for the positioning of each drone with respect to the aircraft,
(E3) collecting, at one or more of the drones, measured data or calculated data regarding atmospheric variables generated by the characterization equipment and data regarding the positioning of the one or more drones,
(E4) transmitting the measured data thus collected from these one or more drones to the aircraft, and
(E5) processing the measured data thus transmitted so as to identify one or more atmospheric phenomena liable to affect the static and/or dynamic behavior of the aircraft.

The processing step (E5) can advantageously be arranged so as to identify an occurrence of a gust of wind at a distance from the aircraft.

In a first configuration, the data collected in one or more of the drones can comprise measured data regarding the speed and strength of the wind experienced by these one or more drones.

In a second configuration, the data collected in one or more of the drones can comprise calculated data regarding the speed and strength of the wind experienced by these one or more drones.

The step (E3) of collecting wind strength and direction data carried out in one drone from among the plurality of deployed drones can comprise a step (E31) for measuring the current drawn by the electric motors driving the rotors with which the drone is equipped, as well as its inertial data, and a step (E32) for processing these current measurements in combination with inertial, positioning and orientation (heading) data for the drone (position, speed, acceleration, orientation, rotational speed), and with its performance curves, in order to infer therefrom an estimate of the strength and direction of the wind.

The characterization method according to the present disclosure can further comprise, prior to the deployment step, a step (Ei) for planning the deployment of the plurality of drones according to weather forecast information received in the aircraft.

The characterization method according to the present disclosure can further comprise a step (Ec) for controlling, in real time, the respective positions of the deployed drones according to results for the identification of atmospheric phenomena.

The characterization method according to the present disclosure can further comprise one or more steps (Eg) for managing the range of the plurality of drones according to information for estimating the energy stored in the drones, respectively.

The processing step (E5) can be arranged so as to detect, in advance, a variation in pressure and/or temperature in an environment close to the aircraft, which is liable to affect the static lift of the aircraft.

According to another aspect of the present disclosure, a system is provided for characterizing, in real time, atmospheric conditions in the environment of an aircraft, the system implementing the characterization method according to the present disclosure, this system comprising:
a plurality of drones carrying equipment for characterizing atmospheric conditions, the drones being intended to be deployed at a distance from the aircraft,
within the aircraft, means for calculating and transmitting instructions for the positioning of each drone with respect to the aircraft,
means, carried in one or more of the drones, for collecting measured data or calculated data regarding atmospheric variables generated by the characterization equipment and data regarding the positioning of the one or more drones,
means for transmitting the measured data thus collected from the one or more drones to the aircraft, and
means, carried within the aircraft, for processing the measured data thus transmitted so as to identify one or more atmospheric phenomena liable to affect the static and/or dynamic behavior of the aircraft.

The processing means can be arranged so as to identify an occurrence of a gust of wind at a distance from the aircraft.

At least one drone from among the plurality of drones can comprise means for measuring the speed and strength of the wind experienced by these one or more drones.

At least one drone from among the plurality of drones can comprise means for calculating the speed and strength of the wind experienced by these one or more drones.

The means for calculating the speed and strength of the wind can comprise means for measuring the current drawn by the electric motors driving the rotors with which the drone is equipped, and means for processing these current measurements in combination with positioning data for the drone in order to infer therefrom an estimate of the strength and direction of the wind.

At least one drone from among the plurality of drones comprises means for detecting, in advance, a variation in pressure and/or temperature in an environment close to the aircraft, which is liable to affect the static lift of the aircraft.

The characterization system according to the present disclosure can further comprise means for controlling, in real time, the respective positions of the deployed drones according to results from processing measured data or calculated atmospheric conditions.

The characterization system according to the present disclosure can further comprise means for managing the range of the plurality of drones according to information for estimating the energy stored in the drones, respectively.

According to yet another aspect of the present disclosure, a drone is provided for characterizing, in real time, atmospheric conditions in the environment of an aircraft, the drone being implemented in a characterization system according to the present disclosure, the drone comprising:
one or more items of on-board equipment for characterizing atmospheric conditions,
means for collecting measured data or calculated data regarding atmospheric variables generated by the one or more items of characterization equipment and data regarding the positioning of the drone, and
means for transmitting the measured data thus collected to the aircraft.

The one or more items of on-board equipment can comprise a LIDAR sensor arranged so as to deliver information on the direction and strength of the wind.

An aircraft equipped with a system for characterizing atmospheric conditions according to the present disclosure is also provided, the aircraft being characterized in that it comprises:
means for accommodating a plurality of drones provided with on-board equipment for characterizing atmospheric conditions,
means for calculating and transmitting, to all or some of the drones, instructions for the positioning of each drone with respect to the airship,
means for collecting information on wind strength and direction and on positioning determined in each of the drones and transmitted from each of the drones, and
means for processing the determined wind and positioning information thus collected so as to identify one or more sudden wind accelerations at a distance from the airship.

The aircraft according to the present disclosure can further comprise means for managing the range of all or some of the drones of the plurality of drones.

The characterization method and system according to the present disclosure can advantageously be implemented for airships, helicopters, vertical take-off and landing (VTOL) aircraft and city taxis.

### BRIEF DESCRIPTION OF THE DRAWINGS

Other advantages and particularities of the present disclosure will become apparent on reading the detailed description of implementations and embodiments, which are in no way exhaustive, with reference to the appended drawings, in which:

FIG. 1 schematically shows a side view of one embodiment of an airship equipped with a system according to the present disclosure;

FIG. 2 schematically shows a bottom view of the airship shown in FIG. 1;

FIG. 3 schematically shows the system implemented in FIG. 1; and

FIG. 4 schematically shows a method implemented by the airship shown in FIG. 1.

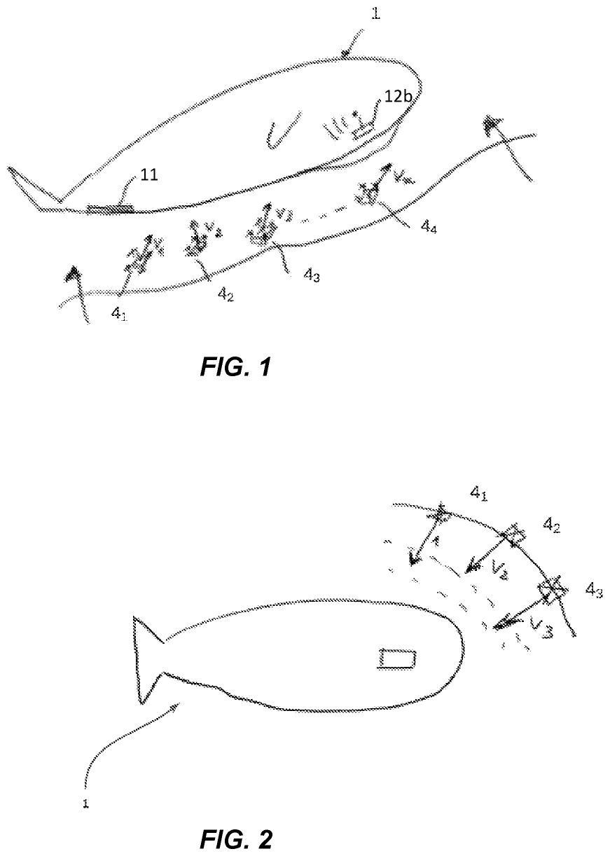

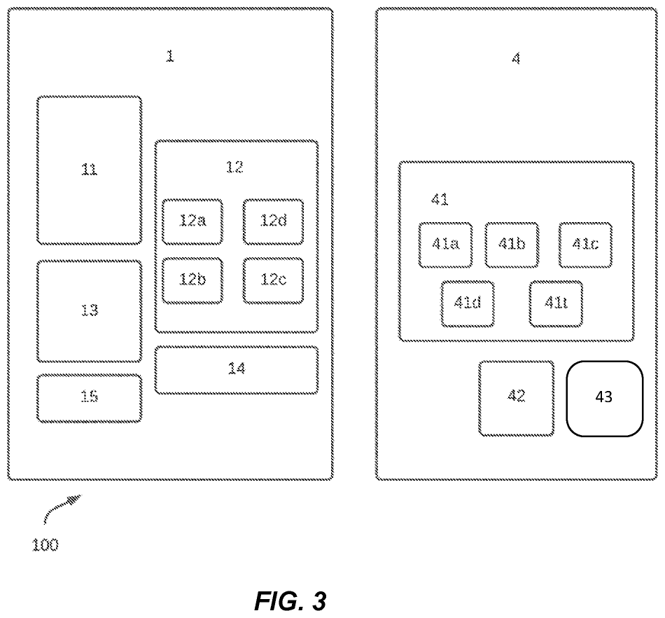

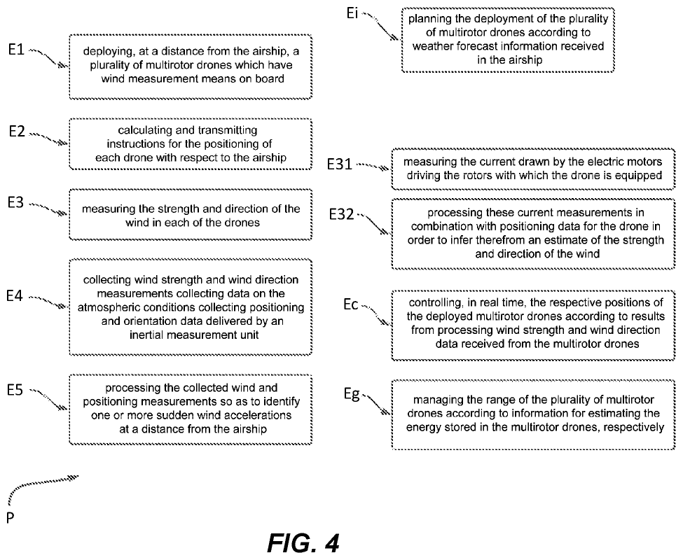

### DETAILED DESCRIPTION

Since the embodiments described below are in no way limiting, it will be possible, in particular, to consider variants of the present disclosure comprising only a selection of the features described, subsequently isolated from the other features described, if this selection of characteristics is sufficient to confer a technical advantage or to differentiate embodiments of the present disclosure from the prior art. This selection comprises at least one feature, preferably functional, without structural details, or with only a portion of the structural details if this part only is sufficient to confer a technical advantage or to differentiate embodiments of the present disclosure from the prior art.

In the figures, an element appearing in several figures retains the same reference.

An airship 1 equipped with a system 100 for detecting gusts of wind is now described with reference to the figures.

The system 100 comprises means 11, arranged within the airship, for accommodating a plurality of drones 4, such as the drones 4₁, 4₂, 4₃, . . . , 4ₙ. The means 11 can, for example, be formed from an airship hold. The drones can, for example, be multirotor drones, without this feature being limiting.

The drones are intended to be deployed at a distance from the airship 1.

According to one possibility, all or some of the drones are held on board the airship within the means 11 and are deployed from the airship.

The drones can be held on board another airship and deployed from this other airship. According to another possibility, the drones are held within a drone hosting station and are deployed from this station, the station being able to be on land or at sea.

The system 100 comprises means 12a, on board the airship, for calculating and transmitting, to each of the drones 4₁, 4₂, 4₃, . . . , 4ₙ, instructions for the positioning of each drone with respect to the airship.

The system 100 comprises means 4₁, 4₂, 4₃, . . . , 4ₙ, on board each of the drones 4, for determining the strength and direction of the wind.

The strength and direction of the wind can be determined along three axes forming an orthogonal basis, for example, in the reference frame of the aircraft.

A number of techniques can be envisaged for determining the strength and direction of the wind.

The drone can, for example, be equipped with an anemometer 41a and processing means 41t for processing the measurements from the anemometer.

According to another possibility, the drone can be equipped with a LIDAR 41b, the processing means 41t being configured to process these measurements.

According to yet another possibility, the drone can be equipped with means 41c for positioning the drone, the processing means 41t being configured to determine an estimate of the strength and direction of the wind from the knowledge of two position fixes for the drone.

As a preferred exemplary embodiment of the present disclosure, drones associated with the airship are equipped with positioning means and with accelerometers (the information from which can be processed and transmitted), which makes it possible to calculate the wind speed by using the ground speed. It is also possible to envisage drones associated with the airship being equipped with an inertial measurement unit configured to deliver positioning, speed and orientation information.

According to yet another possibility, a drone according to the present disclosure is equipped with an inertial measurement unit intended to deliver positioning and orientation data, and means 41d for measuring the current drawn by the electric motors driving the rotors with which the drone is equipped.

The processing means 41t are configured to process these current measurements in combination with positioning data for the drone in order to infer therefrom a calculation of the strength and direction of the wind. This calculation can be performed on the basis of the knowledge of the drawn current and of the performance model for the drone.

When the drone comprises more than one item of equipment for calculating the strength and direction of the wind, the processing means 41t can further be configured to fuse the calculation results from the items of equipment.

The drone can further comprise means for measuring atmospheric pressure and/or relative humidity and/or temperature. These pressure, humidity and temperature measurements can be used to help anticipate variations in aerostatic lift.

The system 100 comprises means 42, on board each of the drones 4, for transmitting the wind strength, wind direction and positioning measurements v₁, v₂, v₃, . . . , vₙ measured by the means 41 in the three dimensions x, y, z.

The system 100 can further comprise means 43, on board at least one of the drones 4, preferably in each of the drones 4₁, 4₂, 4₃, . . . , 4ₙ, for communicating with another drone of the plurality of drones 4₁, 4₂, 4₃, . . . , 4ₙ.

The system 100 comprises means 12b, on board the airship, for collecting wind strength, wind direction and positioning measurements v₁, v₂, v₃, . . . , vₙ measured in each of the drones 4₁, 4₂, 4₃, . . . , 4ₙ and transmitted from each of the drones 4₁, 4₂, 4₃, . . . , 4ₙ.

The system 100 comprises means 12c for processing the wind and positioning measurements v₁, v₂, v₃, . . . , vₙ thus collected so as to identify one or more sudden wind accelerations at a distance from the airship.

According to one possibility, the means 12b for processing the wind and positioning measurements are at least partly held on board the airship.

These processing means 12b can be entirely held on board the airship.

Alternatively, the processing means 12b can comprise devices external to the airships. Wireless communication means are then provided between the devices on board the airship and the devices external to the airship. Such wireless communication means are well known and are not described again here.

The use of an artificial intelligence system dedicated to processing the data transmitted by the swarm of drones in real time makes it possible to transmit clear, concise and useful information intended for the pilot or autopilot. It can be, in particular, “GO”- and “NO-GO”-type information based on air conditions.

Thus, the airship can anticipate these variations in order to stabilize its position more effectively and optimize the operating times. The analysis of the change in the environment, the reactions of the airship and the results obtained will allow the flight simulator, and subsequently the autopilot, to progressively improve.

The system 100 can comprise means 12d, on board the airship, for managing the range of all or some of the drones of the plurality of drones 4, in particular, based on information for estimating the energy stored in the drones. The estimate of the stored energy can be obtained from the flight distance traveled by the drones and from the elapsed time. When the drone comprises a means for measuring current drawn by the electric motors driving the rotors with which the drone is equipped, the estimate of the energy stored by the drone can be made on the basis of the measurement of the drawn current.

The system 100 can further comprise means 14 for planning the deployment of the plurality of drones according to weather forecast information received in the airship. The means 14 are preferably on board the airship. The means 14 can, for example, be formed by a processing unit. The weather forecast information received in the airship can, for example, come from a weather station on the airship or from an atmospheric information system external to the airship.

The system 100 can further comprise means 15 for controlling, in real time, the respective positions of the deployed drones 4₁, 4₂, 4₃, . . . , 4ₙ according to results from processing wind strength and wind direction data received from the drones. The means 15 are typically formed by a processing unit that is configured to generate positions from the measurements collected by the means 12b.

The method P for detecting gusts of wind comprises:
a step E1 of deploying, at a distance from the airship 1, a plurality of drones (4₁, 4₂, 4₃, . . . , 4ₙ) that have wind measurement means (41) on board,
a step E2 of calculating and transmitting instructions for the positioning of each drone with respect to the airship,
a step E3 of measuring the strength and direction of the wind in each of the drones,
a step E4 of collecting wind strength, wind direction and positioning measurements measured in each of the drones, and
a step E5 of processing the wind and positioning information thus collected so as to identify one or more sudden wind accelerations at a distance from the airship.

Subsequent to step E4, the method can comprise for a step Ec for controlling, in real time, the respective positions of the deployed drones (4₁, 4₂, 4₃, 4ₙ) according to results from processing wind strength and wind direction data received from the drones.

According to one embodiment, step E3 of measuring the strength and direction of the wind carried out in one drone from among the plurality of deployed drones can comprise a step E31 for measuring the current drawn by the electric motors driving the rotors with which the drone is equipped, and a step E32 for processing these current measurements in combination with positioning and orientation data for the drone, and its performance curves, in order to infer therefrom an estimate of the strength and direction of the wind.

These positioning and orientation data can be extracted from complete inertial data delivered by an inertial measurement unit with which the drone is equipped.

Prior to the deployment step, the method P can comprise a step Ei for planning the deployment of the plurality of drones 4₁, 4₂, 4₃, . . . , 4ₙ according to weather forecast information received in the airship.

The method P can also comprise one or more steps Eg for managing the range of the plurality of drones according to information for estimating the energy stored in the drones 4₁, 4₂, 4₃, . . . , 4ₙ, respectively.

The information collected using a method or system according to the present disclosure allows the pilot to be kept informed. The apparent mass of the airship, its power reserve and the information collected are used to inform the pilot as to the controllability of the airship and maintaining its altitude. In addition, the information collected can be transmitted to the flight management system in order to anticipate and minimize the effects of detected gusts.

Of course, the present disclosure is not limited to the examples that have just been described and numerous modifications can be made to these examples without departing from the scope of the invention as defined by the claims. In addition, the different features, forms, variants and embodiments of the disclosure may be associated with one another in various combinations insofar as they are not incompatible or exclusive of one another.

The measurements of atmospheric conditions include measurements of experienced phenomena that cannot be modeled (gusts, sunshine) and physical phenomena that can be modeled (temperature, pressure, hygrometry, cloud movement).

1. A method for characterizing, in real time, atmospheric conditions in the environment of an aircraft, the method comprising the following steps:
deploying, at a distance from the aircraft, a plurality of drones carrying equipment for characterizing atmospheric conditions,
calculating and transmitting instructions for the positioning of each drone with respect to the aircraft,
collecting, at one or more of the drones, measured data or calculated data regarding atmospheric variables generated by the characterization equipment and data regarding the positioning of the one or more drones,
transmitting the measured data thus collected from these one or more drones to the aircraft, and
processing the measured data thus transmitted so as to identify one or more atmospheric phenomena liable to affect the static and/or dynamic behavior of the aircraft.

2. The method of claim 1, wherein the processing step comprises identifying an occurrence of a gust of wind at a distance from the aircraft.

3. The method of claim 2, wherein the data collected in one or more of the drones comprises measured data regarding the speed and strength of the wind experienced by the one or more drones.

4. The method of claim 2, wherein the data collected in one or more of the drones comprises calculated data regarding the speed and strength of the wind experienced by the one or more drones.

5. The method of claim 4, wherein the calculated data regarding the speed and strength of the wind experienced by the one or more drones is obtained by measuring current drawn by electric motors driving rotors of the one or more drones to obtain current measurements, and the method further comprises processing the current measurements in combination with positioning data and performance curves for the one or more drones to estimate the strength and direction of the wind.

6. The method of claim 1, further comprising, prior to the step of deploying the plurality of drones, planning a deployment of the plurality of drones according to weather forecast information received in the aircraft.

7. The method of claim 1, further comprising controlling, in real time, respective positions of the deployed drones in response to identified atmospheric phenomena.

8. The method of claim 1, further comprising managing a range of the plurality of drones according to an amount of energy stored in the drones, respectively.

9. The method of claim 1, wherein the processing step comprises detecting, in advance, a variation in pressure and/or temperature in an environment close to the aircraft liable to affect a static lift of the aircraft.

10. A system for characterizing, in real time, atmospheric conditions in the environment of an aircraft, the system comprising:
carrying equipment for characterizing atmospheric conditions, the drones being configured to be deployed at a distance from the aircraft,
within the aircraft, means for calculating and transmitting instructions for the positioning of each of the drones with respect to the aircraft,
means, carried in one or more of the drones, for collecting measured data or calculated data regarding atmospheric variables generated by the equipment for characterizing the atmospheric conditions and data regarding the positioning of the drones,
means for transmitting the measured data thus collected from the drones to the aircraft, and
means, carried within the aircraft, for processing the measured data thus transmitted so as to identify one or more atmospheric phenomena liable to affect static and/or dynamic behavior of the aircraft.

11. The system of claim 10, wherein the processing means are configured to identify an occurrence of a gust of wind at a distance from the aircraft.

12. The system of claim 11, wherein at least one of the drones comprises means for measuring a speed and a strength of wind experienced by the at least one of the drones.

13. The system of claim 11, wherein at least one of the drones comprises means for calculating a speed and a strength of wind experienced by the at least one of the drones.

14. The system of claim 13, wherein the means for calculating the speed and the strength of the wind comprises means for measuring current drawn by an electric motor driving a rotor of the at least one of the drones to obtain current measurements, and means for processing the current measurements in combination with positioning data and performance curves for the at least one of the drones and estimating the strength and a direction of the wind.

15. The system of claim 10, wherein at least one of the drones comprises means for detecting, in advance, a variation in pressure and/or temperature in an environment close to the aircraft liable to affect a static lift of the aircraft.

16. The system of claim 10, further comprising means for controlling, in real time, respective positions of the deployed drones according to results from processing measured data or calculated atmospheric conditions.

17. The system of claim 10, further comprising means for managing ranges of the drones according to information regarding an amount of energy stored in the drones, respectively.

18. A drone for characterizing, in real time, atmospheric conditions in the environment of an aircraft, implemented in a characterization system according to claim 10, the drone comprising:
one or more items of on-board equipment for characterizing atmospheric conditions,
means for collecting measured data or calculated data regarding atmospheric variables generated by the one or more items of characterization on-board equipment and data regarding the positioning of the drone, and
means for transmitting the measured data thus collected to the aircraft.

19. The drone of claim 19, wherein the one or more items of on-board equipment comprise a LIDAR sensor configured to deliver information relating to a direction and a strength of wind.

20. An aircraft equipped with a system for characterizing atmospheric conditions according to claim 10, the aircraft comprising:
means for accommodating a plurality of drones provided with on-board equipment for characterizing atmospheric conditions,
means for calculating and transmitting, to all or some of the drones, instructions for the positioning of each of the drones with respect to the airship,
means for collecting information on wind strength and direction and on positioning determined in each of the drones and transmitted from each of the drones, and
means for processing the determined wind and positioning information thus collected to identify one or more wind accelerations at a distance from the aircraft.

21. The aircraft of claim 20, further comprising means for managing a range of at least one of the drones.
